(19) United States
(12) Patent Application Publication
(10) Pub. No.: US 2013/0308298 A1
(43) Pub. Date: Nov. 21, 2013

(54) MICROELECTRO-MECHANICAL SYSTEM DISPLAY

(71) Applicant: InnoLux Corporation, Miao-Li County (TW)

(72) Inventors: Yu-Ming HUANG, Miao-Li County (TW); Te-Yu LEE, Miao-Li County (TW)

(73) Assignee: InnoLux Corporation, Miao-Li County (TW)

(21) Appl. No.: 13/898,668

(22) Filed: May 21, 2013

(30) Foreign Application Priority Data
May 21, 2012 (TW) 101117961

(51) Int. Cl. G02B 26/02

(52) U.S. Cl. CPC G02B 26/02
USPC 362/97.1

(57) ABSTRACT

The invention provides a microelectro-mechanical system display (MEMS display), including: a first substrate, wherein the first substrate includes a first surface and a second surface; a second substrate formed on the first surface of the first substrate; a digital micro shutter formed between the first substrate and the second substrate; a backlight module formed on a surface of the second substrate far away from the digital micro shutter; and a first optical layer formed below the second surface of the first substrate.

### CROSS REFERENCE TO RELATED APPLICATIONS

This Application claims priority of Taiwan Patent Application No. 101117961, filed on May, 21, 2012, the entirety of which is incorporated by reference herein.

### BACKGROUND OF THE DISCLOSURE

1. Field of the Disclosure

The present disclosure relates to a microelectro-mechanical system display (MEMS display), and in particular, relates to an MEMS display having a light reflective layer or light absorption layer.

2. Description of the Related Art

Displays are becoming increasingly diverse with the rapid progress of science and technology. Liquid crystal displays are widely used in personal computers, personal digital assistants (PDAs), mobile phones and TVs, due to the advantages of being light, having low power consumption, and having no radiation contamination.

The light intensity of a backlight module of the liquid crystal displays after passing through a color filter is controlled by the polarization property of the liquid crystal. However, the light intensity of liquid crystal displays is reduced when the light passes through the color filter. Thus, a new microelectro-mechanical system display (MEMS display) has been developed.

A light is directed toward to an aperture of the MEMS display, and then light penetration is controlled by the aperture per unit time. Thus, the different colors of the light are emitted at different time periods. Compared with conventional liquid crystal displays (LCD display), the color filter is not needed in the MEMS display, and thus MEMS displays have little light loss and consume less power.

The disadvantage of the MEMS display is that dazzle problems occur to cause viewers to feel uncomfortable. In order to resolve the dazzle problems, the invention provides a new type of MEMS display.

### BRIEF SUMMARY OF THE DISCLOSURE

The invention provides a microelectro-mechanical system display (MEMS display), comprising: a first substrate, wherein the first substrate comprises a first surface and a second surface; a second substrate formed on the first surface of the first substrate; a digital micro shutter formed between the first substrate and the second substrate; a backlight module formed on a surface of the second substrate far away from the digital micro shutter; and a first optical layer formed below the second surface of the first substrate.

A detailed descriptions are given in the following embodiments with reference to the accompanying drawings.

### BRIEF DESCRIPTION OF THE DRAWING

For a more complete understanding of the present disclosure, and the advantages thereof, reference is now made to the following descriptions taken in conjunction with the accompanying drawings, in which:

FIG. 1 shows a top-view of a microelectro-mechanical system display (MEMS display) in accordance with an embodiment of the invention;

FIG. 2A shows a cross-sectional schematic representation of a microelectro-mechanical system display (MEMS display) in accordance with a first embodiment of the invention;

FIG. 2B shows a cross-sectional schematic representation of a microelectro-mechanical system display (MEMS display) in accordance with a second embodiment of the invention;

FIG. 2C shows a cross-sectional schematic representation of a microelectro-mechanical system display (MEMS display) in accordance with a third embodiment of the invention;

FIG. 2D shows a cross-sectional schematic representation of a microelectro-mechanical system display (MEMS display) in accordance with a fourth embodiment of the invention; and

FIG. 2E shows a cross-sectional schematic representation of a microelectro-mechanical system display (MEMS display) in accordance with a fifth embodiment of the invention.

### DETAILED DESCRIPTION OF THE DISCLOSURE

The following descriptions are of the best-contemplated mode of carrying out the disclosure. This descriptions are made for the purpose of illustrating the general principles of the disclosure and should not be taken in a limiting sense. The scope of the disclosure is best determined by reference to the appended claims.

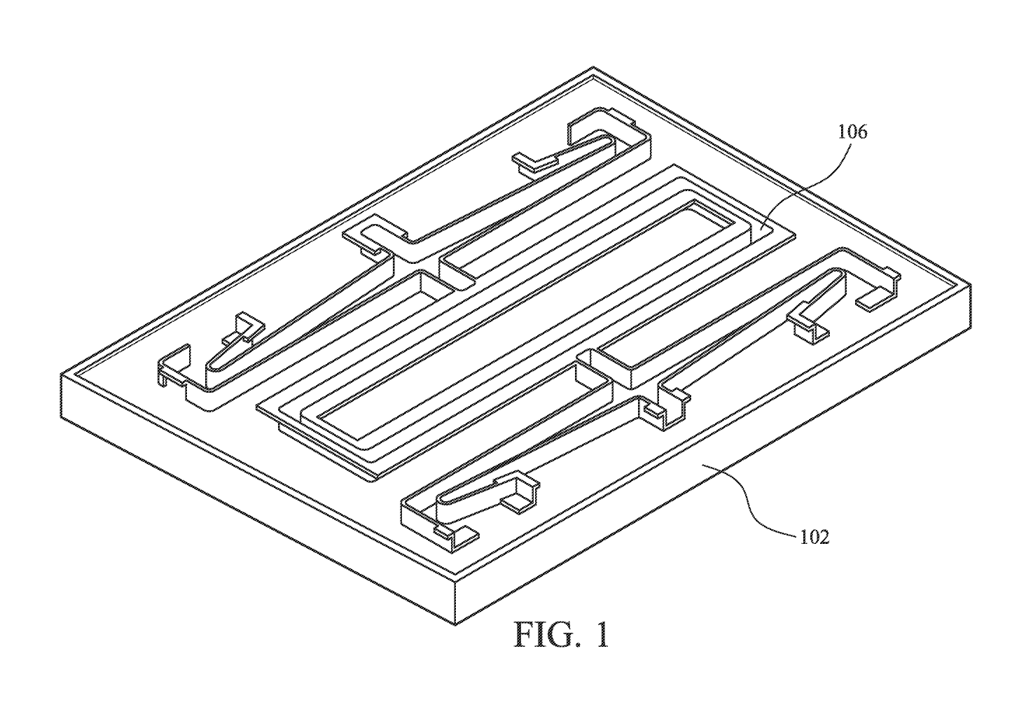

FIG. 1 shows a top-view of a microelectro-mechanical system display (MEMS display) of the invention. A digital micro shutter 106 is formed on a first substrate 102. For purposes of simplifying the description of the invention, only the digital micro shutter 106 and the first substrate 102 are shown in FIG. 1. However, other devices may be formed on the first substrate 102.

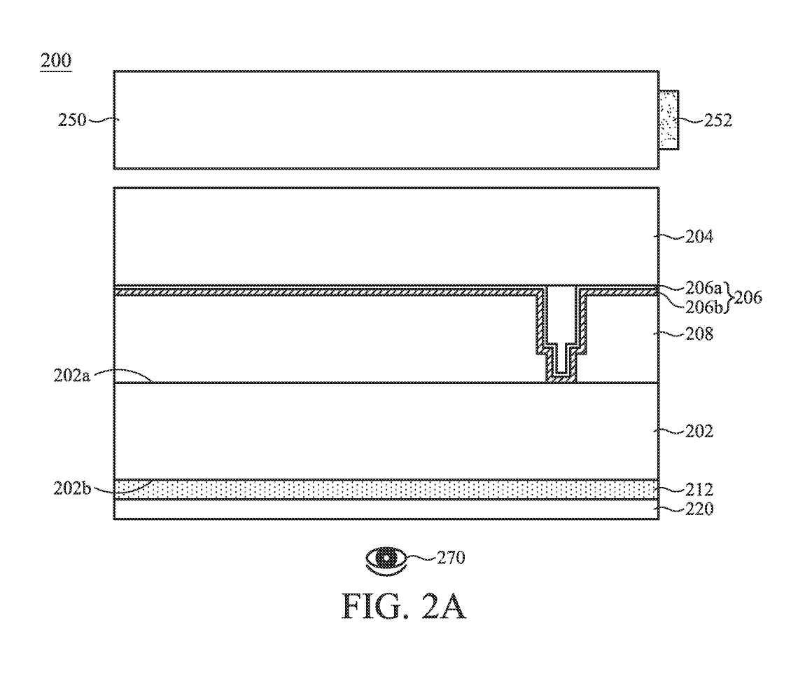

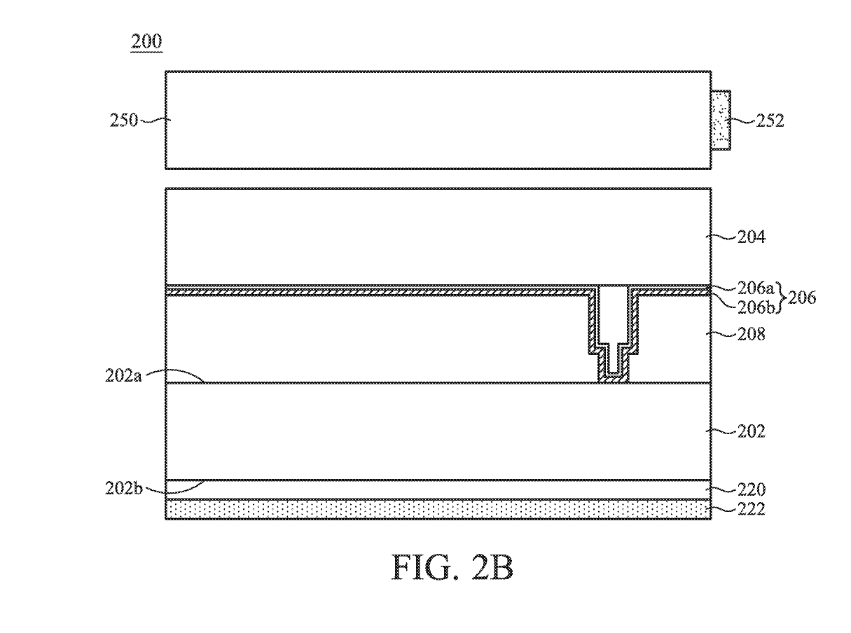

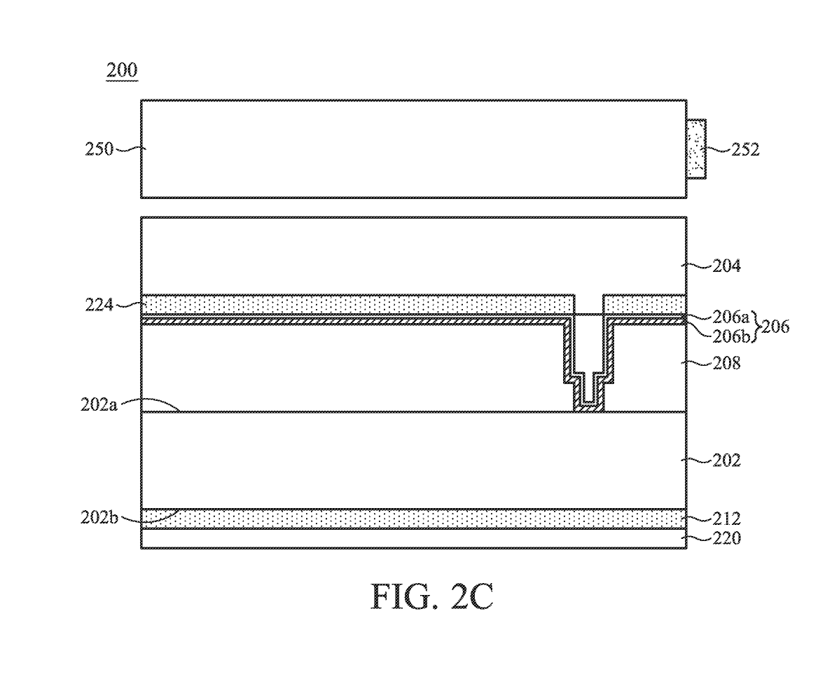

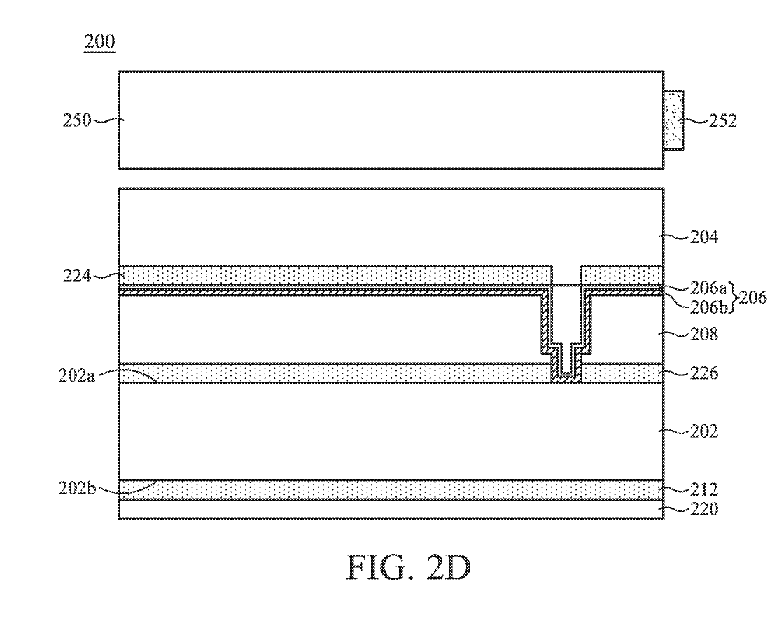

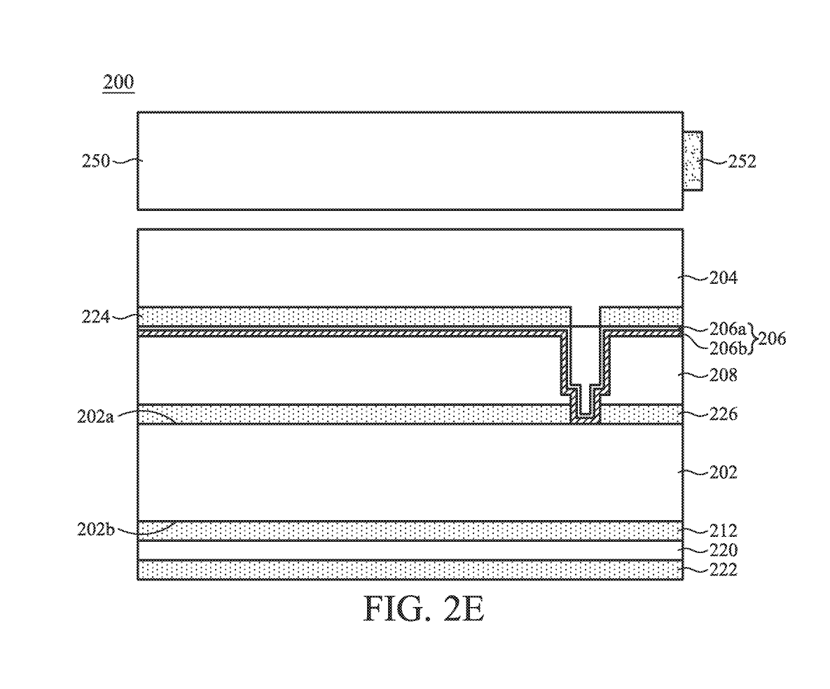

FIG. 2A shows a cross-sectional schematic representations of a microelectro-mechanical system display (MEMS display) 200 of the invention. The MEMS display 200 comprises a first substrate 202, wherein the first substrate 202 comprises: a first surface 202a and a second surface 202b; a second substrate 204 formed on the first surface 202a of the first substrate 202; a digital micro shutter 206 formed between the first substrate 202 and the second substrate 204; a backlight module 250 formed on a surface of the second substrate 204 far away from the digital micro shutter 206; and a transparent cover plate 220 formed below the second surface 202b of the first substrate 202.

Note that a first optical layer 212 is formed between the first substrate 202 and the transparent cover plate 220. The first optical layer 212 is used to refract or absorb a light to reduce dazzle so as to prevent the observer 270, who observed from the second surface 202b of the first substrate 202, from feeling uncomfortable. Another function of the first optical layer 212 is to prevent the leakage of the internal circuit layout.

The first optical layer 212 comprises a single layer or multi-layers. The first optical layer 212 comprises silicon oxide (SiO₂), silicon nitride (Si₃N₄), chromium oxide (Cr₂O₃) or chromium nitride (CrN).

The first optical layer 212 has a refractive index (n) of about 1.5-5, a reflectance of about 0.1-10% and a thickness of about 1-50 nm.

The digital micro shutter 206 comprises an amorphous silicon layer (a-Si layer) 206a and a metal layer 206b. The metal layer 206b comprises alumina (Al), chromium (Cr), gold (Au), silver (Ag), copper (Cu), molybdenum (Mo), titanium (Ti), tantalum (Ta) or combinations thereof.

The transparent cover plate 220 comprises glass or plastic substrate. The plastic substrate comprises polycarbonate (PC), poly ethylene terephthalate (PET), polyethylene naphthalate (PEN), polyimide (PI), poly vinyl alcohol (PVA), poly polyvinylpyrrolidone (PVP) or polymethyl methacrylate (PMMA).

Additionally, the MEMS display 200 of the invention further comprises a thin film transistor (not shown) formed on the first substrate 202 or the second substrate 204. The thin film transistor comprises Organic Thin Film Transistor (OTFT), low temperature poly silicon TFTs, metal oxide TFTs, amorphous silicon TFTs, micro-crystal silicon TFTs, polycrystalline silicon TFTs, single crystal silicon TFTs, oxide TFTs or organic TFTs.

The thin film transistor may be formed by a photolithography process which comprises photoresist coating, soft baking, mask aligning, exposure, post-exposure, developing photoresist and hard baking. The photolithography process is known to those skilled in the art, and thus descriptions are omitted here.

The MEMS display 200 of the invention further comprises a light source 252 formed on a side of the backlight module 250. The light source 252 is such as a Light emitting diode (LED). Furthermore, a gap 208 is formed between the digital micro shutter 206 and the first substrate 202, and a vacuum, gas or liquid may be filled into the gap 208.

FIG. 2B shows a cross-sectional schematic representations of a microelectro-mechanical system display (MEMS display) 200 of a second embodiment of the invention, wherein like elements are identified by the same reference numbers as in FIG. 2A, and thus descriptions are omitted for brevity. In FIG. 2B, the first optical layer 222 is formed below the transparent cover plate 220.

FIG. 2C shows a cross-sectional schematic representations of a microelectro-mechanical system display (MEMS display) 200 of a third embodiment of the invention, wherein like elements are identified by the same reference numbers as in FIG. 2A, and thus repeated descriptions are omitted for brevity.

In FIG. 2C, the first optical layer 212 is formed between the first substrate 202 and the transparent cover plate 220, and the second optical layer 224 is formed between the second substrate 204 and the digital micro shutter 206. In the third embodiment, more light is refracted or absorbed by the two optical layers (212,224) to reduce dazzle.

FIG. 2D shows a cross-sectional schematic representations of a microelectro-mechanical system display (MEMS display) 200 of a fourth embodiment of the invention, wherein like elements are identified by the same reference numbers as in FIG. 2A, and thus repeated descriptions are omitted for brevity.

There are three optical layers in FIG. 2D, wherein the first optical layer 212 is formed between the first substrate 202 and the transparent cover plate 220, the second optical layer 224 is formed between the second substrate 204 and the digital micro shutter 206, and the third optical layer 226 is formed between the digital micro shutter 206 and the first substrate 202.

FIG. 2E shows a cross-sectional schematic representations of a microelectro-mechanical system display (MEMS display) 200 of a fifth embodiment of the invention, wherein like elements are identified by the same reference numbers as in FIG. 2A, and thus repeated descriptions are omitted for brevity.

There are four optical layers in FIG. 2E, wherein the first optical layers (212, 222) are formed between the first substrate 202 and the transparent cover plate 220 and below the transparent cover plate 220, the second optical layer 224 is formed between the second substrate 204 and the digital micro shutter 206, and the third optical layer 226 is formed between the digital micro shutter 206 and the first substrate 202.

Note that a single layer or multi-layers of the optical layer are formed in first embodiment to the fifth embodiment. The thickness and location of the optical layer are not limited to the above embodiments and may be adjusted according to the actual application to those skilled in the art.

From the above description, the light is refracted or absorbed by the different locations of the optical layers of the invention to reduce dazzle so as to prevent the observer from feeling uncomfortable.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microelectro-mechanical system display (MEMS display), comprising:
a first substrate, wherein the first substrate comprises a first surface and a second surface;
a second substrate formed on the first surface of the first substrate;
a digital micro shutter formed between the first substrate and the second substrate;
a backlight module formed on a surface of the second substrate far away from the digital micro shutter; and
a first optical layer formed below the second surface of the first substrate.

2. The microelectro-mechanical system display as claimed in claim 1, further comprising a transparent cover plate formed below the second surface of the first substrate.

3. The microelectro-mechanical system display as claimed in claim 2, wherein the first optical layer is formed between the first substrate and the transparent cover plate.

4. The microelectro-mechanical system display as claimed in claim 1, wherein the first optical layer is formed below the transparent cover plate.

5. The microelectro-mechanical system display as claimed in claim 2, wherein the transparent cover plate comprises glass or plastic substrate.

6. The microelectro-mechanical system display as claimed in claim 5, wherein the plastic substrate comprises polycarbonate (PC), poly ethylene terephthalate (PET), polyethylene naphthalate (PEN), polyimide (PI), poly vinyl alcohol (PVA), poly polyvinylpyrrolidone (PVP) or polymethyl methacrylate (PMMA).

7. The microelectro-mechanical system display as claimed in claim 1, wherein the digital micro shutter comprises an amorphous silicon layer (a-Si layer) and a metal layer.

8. The microelectro-mechanical system display as claimed in claim 7, wherein the metal layer comprises alumina (Al), chromium (Cr), gold (Au), silver (Ag), copper (Cu), molybdenum (Mo), titanium (Ti), tantalum (Ta) or combinations thereof.

9. The microelectro-mechanical system display as claimed in claim 1, further comprising a second optical layer formed between the second substrate and the digital micro shutter.

10. The microelectro-mechanical system display as claimed in claim 9, wherein the second optical layer comprises silicon oxide (SiO₂), silicon nitride (Si₃N₄), chromium oxide (Cr₂O₃) or chromium nitride(CrN).

11. The microelectro-mechanical system display as claimed in claim 1, further comprising a third optical layer formed between the digital micro shutter and the first substrate.

12. The microelectro-mechanical system display as claimed in claim 11, wherein the third optical layer comprises silicon oxide (SiO₂), silicon nitride (Si₃N₄), chromium oxide (Cr₂O₃) or chromium nitride(CrN).

13. The microelectro-mechanical system display as claimed in claim 1, wherein the first substrate or the second substrate is a thin film transistor substrate.

14. The microelectro-mechanical system display as claimed in claim 1, wherein the first optical layer is a single layer or multi-layers.

15. The microelectro-mechanical system display as claimed in claim 1, wherein the first optical layer comprises silicon oxide (SiO₂), silicon nitride (Si₃N₄), chromium oxide (Cr₂O₃) or chromium nitride(CrN).

16. The microelectro-mechanical system display as claimed in claim 1, wherein the first optical layer has a refractive index (n) of 1.5-5.

17. The microelectro-mechanical system display as claimed in claim 1, wherein the first optical layer has a reflectance of 0.1-10%.

18. The microelectro-mechanical system display as claimed in claim 1, wherein the first optical layer has a thickness of 1-50 nm.

19. The microelectro-mechanical system display as claimed in claim 1, further comprising a light source formed on a side of the backlight module.
